(19) United States
(12) Patent Application Publication
(10) Pub. No.: US 2016/0212305 A1
(43) Pub. Date: Jul. 21, 2016

(54) IMAGE PROCESSING APPARATUS, IMAGE FORMING APPARATUS, AND IMAGE PROCESSING METHOD

(71) Applicant: Norio SAKAI, Kanagawa (JP)

(72) Inventor: Norio SAKAI, Kanagawa (JP)

(73) Assignee: Ricoh Company, Limited, Tokyo (JP)

(21) Appl. No.: 15/000,129

(22) Filed: Jan. 19, 2016

(30) Foreign Application Priority Data
Jan. 21, 2015 (JP) 2015-009709

(51) Int. Cl. H04N 1/60; H04N 1/00; G06F 3/12; H04N 1/23

(52) U.S. Cl. CPC H04N 1/6094; H04N 1/2369; H04N 1/00801; G06F 3/1204; H04N 2201/0094; H04N 2201/33378

(57) ABSTRACT

An image processing apparatus includes a reader configured to read an original to generate original image data; a first color corrector configured to generate CMYK-image information for outputting the original in color from the original image data; a second color corrector configured to generate K-image information for outputting the original in monochrome from the original image data; a determiner configured to determine whether the original is color or monochrome, using the original image data; and an output unit configured to output the CMYK-image information or the K-image information based on a result of determination by the determiner.

### CROSS-REFERENCE TO RELATED APPLICATION

The present application claims priority to and incorporates by reference the entire contents of Japanese Patent Application No. 2015-009709 filed in Japan on Jan. 21, 2015.

### BACKGROUND OF THE INVENTION

1. Field of the Invention

The present invention relates to an image processing apparatus, an image forming apparatus, and an image processing method.

2. Description of the Related Art

Conventionally, color multifunction peripherals have an Auto Color Selection (ACS) function. The ACS function is a function of determining whether an original read by a multifunction peripheral is color or monochrome. Then, according to a result of the determination, the multifunction peripheral outputs an image using chromatic color material if the original is color, or outputs an image using achromatic color material if the original is monochrome.

In Japanese Laid-open Patent Publication No. 2006-238024 (hereinafter, referred to as “Patent Document 1”), there is disclosed a technology capable of suppressing deterioration of image quality when using the ACS function. The technology disclosed in Patent Document 1 scans an original when control of image formation preprocessing has completed, and determines whether it is a color original or a monochrome original. Then, when having determined that it is a color original, the technology disclosed in Patent Document 1 repeatedly performs processes from the scanning of the original up to image development as many times as the number of colors, thereby outputting an image of the original.

However, according to the technology disclosed in Patent Document 1, pixel positions may be shifted due to multiple readings of the same original. Furthermore, the technology disclosed in Patent Document 1 is not compatible with a sheet-through automatic document feeder which can read an original only once.

Therefore, there is a need to provide an image processing apparatus, image forming apparatus, and image processing method capable of increasing the productivity while preventing image degradation.

### SUMMARY OF THE INVENTION

It is an object of the present invention to at least partially solve the problems in the conventional technology.

According to an embodiment, there is provided an image processing apparatus that includes a reader configured to read an original to generate original image data; a first color corrector configured to generate CMYK-image information for outputting the original in color from the original image data; a second color corrector configured to generate K-image information for outputting the original in monochrome from the original image data; a determiner configured to determine whether the original is color or monochrome, using the original image data; and an output unit configured to output the CMYK-image information or the K-image information based on a result of determination by the determiner.

According to another embodiment, there is provided an image processing apparatus that includes a reader configured to read an original to generate original image data; a first color corrector configured to generate CMYK-image information for outputting the original in color from the original image data; a determiner configured to determine whether the original is color or monochrome, using the original image data; a color converter configured to start generation of the K-image information from the CMYK-image information when the determiner determines that the original is monochrome; and an output unit configured to output the CMYK-image information or the K-image information generated by the color converter based on a result of determination by the determiner.

According to still another embodiment, there is provided an image forming apparatus that includes the image processing apparatus according to any one of the above embodiments; and an image forming unit configured to perform image formation based on the CMYK-image information or K-image information output from the image processing apparatus.

According to still another embodiment, there is provided an image processing method that includes reading an original to generate original image data; generating CMYK-image information for outputting the original in color from the original image data; generating K-image information for outputting the original in monochrome from the original image data; determining whether the original is color or monochrome, using the original image data; and outputting the CMYK-image information or the K-image information based on a result of determination at the determining.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram showing an internal configuration of an image forming apparatus according to a first embodiment;

FIG. 2 is a diagram showing an example of a configuration of a control system of the image forming apparatus according to the first embodiment;

FIG. 3 is a functional block diagram showing an example of a functional configuration of a read-image processing unit according to the first embodiment;

FIG. 4 is a functional block diagram showing an example of a functional configuration of a first color correcting unit according to the first embodiment;

FIG. 5 is a functional block diagram showing an example of a functional configuration of a second color correcting unit according to the first embodiment;

FIG. 6 is a timing chart of a copy operation according to the first embodiment;

FIG. 7 is a functional block diagram showing a functional configuration of a read-image processing unit according to a second embodiment;

FIG. 8 is a functional block diagram showing a functional configuration of an output controller according to the second embodiment; and

FIG. 9 is a timing chart of a copy operation according to the second embodiment.

### DETAILED DESCRIPTION OF THE PREFERRED EMBODIMENTS

Exemplary embodiments of an image processing apparatus, an image forming apparatus, and an image processing method will be explained in detail below with reference to accompanying drawings. In the following description, there is provided an example where the image processing apparatus is applied to an image forming apparatus such as a multifunction peripheral (hereinafter, referred to as “MFP”); however, the application of the image processing apparatus is not limited to this. Incidentally, the MFP is an apparatus having at least two functions out of a copy function, a scanner function, a fax function, and a printer function.

### First Embodiment

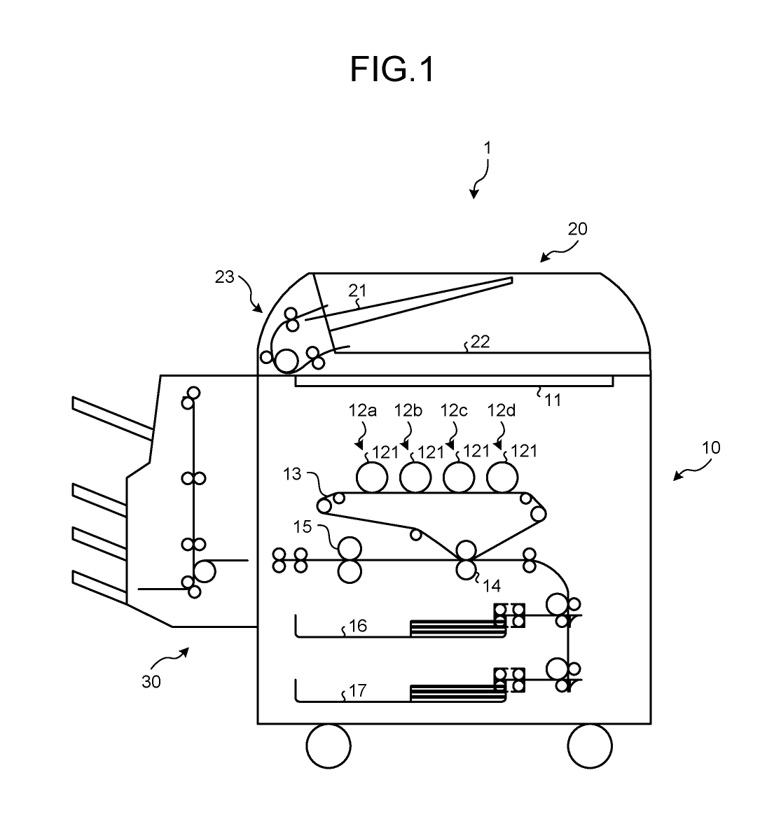

FIG. 1 is a diagram showing an internal configuration of an image forming apparatus 1 according to a first embodiment. The image forming apparatus 1 shown in FIG. 1 includes an image processing apparatus 10, a contact glass 11, image forming stations 12a, 12b, 12c, and 12d, an intermediate transfer belt 13, a transfer roller 14, a fixing roller 15, a first sheet feed tray 16, a second sheet feed tray 17, an auto document feeder (ADF) 20, an original feed table 21, an original receiving tray 22, a conveyance roller 23, and a 3-bin sorter 30.

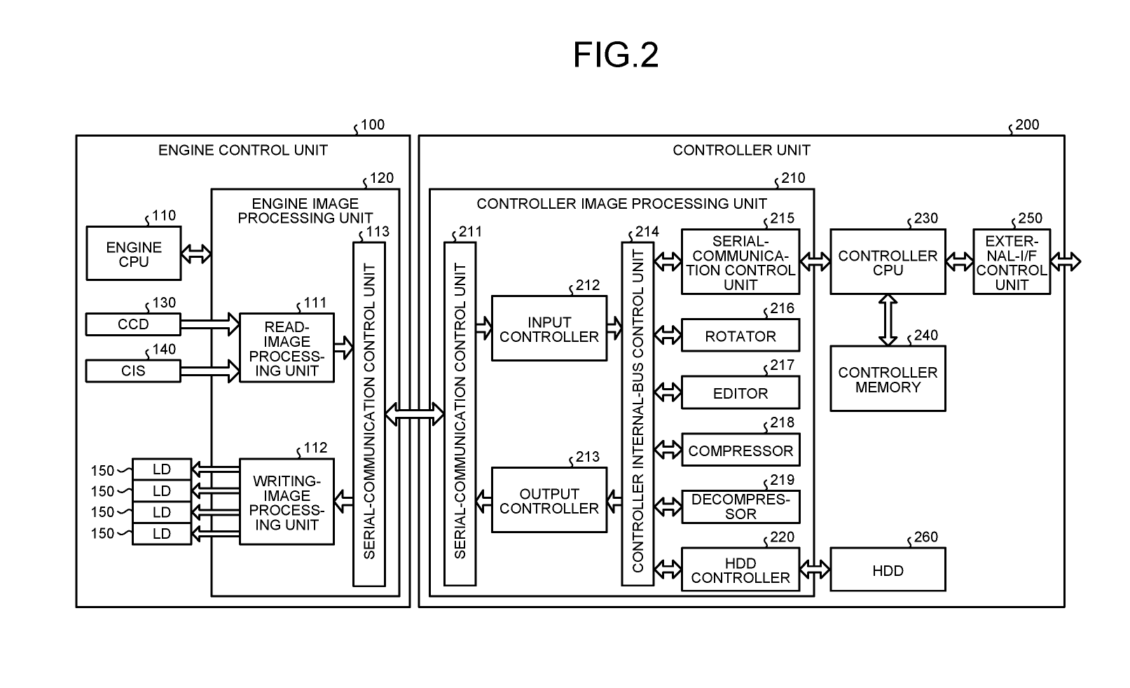

The ADF 20 guides an original set on the original feed table 21 onto the contact glass 11. Then, the ADF 20 causes each original to be read once. At that time, the conveyance roller 23 drives or is driven to convey the original. Then, after a charge coupled device (CCD) 130 (see FIG. 2) or a contact image sensor (CIS) 140 (see FIG. 2) has read the original, the ADF 20 causes the original to be discharged into the original receiving tray 22.

The image processing apparatus 10 generates an RGB image of an original, which has been put on the contact glass 11 or conveyed by the ADF 20, by the CCD 130 or the CIS 140 performing one reading of the original. Then, the image processing apparatus 10 generates a CMYK image or monoK image converted from the RGB image. The RGB image here is image information of a color image having red (R), green (G), and blue (B) colors. The CMYK image is image information of a color image having cyan (C), magenta (M), yellow (Y), and black (K) colors. That is, the CMYK image has four plates of image information of C, M, Y, and K images. The monoK image is image information of a monochrome image having K color. Then, the image processing apparatus 10 prints the CMYK image or the monoK image on a sheet according to whether the original is a color original or a monochrome original.

The image forming stations 12a, 12b, 12c, and 12d form C, M, Y, and K-toner images, respectively. The image forming stations 12a, 12b, 12c, and 12d are arranged at predetermined intervals along the intermediate transfer belt 13. The image forming stations 12a, 12b, 12c, and 12d have the same configuration, except that they differ in color of toner. In the following description, the image forming stations 12a, 12b, 12c, and 12d are described as the image forming station(s) 12 when they are not distinguished.

Each image forming station 12 includes a photoconductor drum 121, a developing unit (not shown), and a laser diode (LD) 150 (see FIG. 2). When the LD 150 irradiates the photoconductor drum 121 with a laser light, an electrostatic latent image is formed on the surface of the photoconductor drum 121. Then, the developing unit applies toner to the photoconductor drum 121 with the electrostatic latent image formed on the surface thereof. The toner remains on a portion irradiated with the laser light, and does not remain on the other portion which has not been irradiated with the laser light. The image forming stations 12 perform the above process for C, M, Y, and K colors, respectively. Consequently, C, M, Y, and K-toner images corresponding to image information are formed on the photoconductor drums 121, respectively.

A toner image formed on the photoconductor drum 121 is transferred onto the intermediate transfer belt 13. In the case of a color original, the image forming stations 12, which are an image forming unit, sequentially transfer C, M, Y, and K-toner images onto the intermediate transfer belt 13 so as to be superimposed on top of one another, thereby a color image is formed. On the other hand, in the case of a monochrome original, the image forming station 12 transfers only a K-toner image onto the intermediate transfer belt 13, thereby a monochrome image is formed.

The transfer roller 14 transfers an image formed on the intermediate transfer belt 13 onto a sheet. The fixing roller 15 fixes the image transferred onto the sheet. Then, the sheet is discharged from the image forming apparatus 1. The first sheet feed tray 16 and the second sheet feed tray 17 are loaded with sheets before an image is formed thereon.

The 3-bin sorter 30 includes a stapler and a shift tray. The 3-bin sorter 30 can bind every predetermined number of sheets with an image fixed thereon in accordance with an instruction based on a print job.

Subsequently, a configuration of a control system of the image forming apparatus 1 is explained. FIG. 2 is a diagram showing an example of the configuration of the control system of the image forming apparatus 1 according to the first embodiment.

The control system of the image forming apparatus 1 broadly includes an engine control unit 100 and a controller unit 200. The engine control unit 100 performs the control of a process of reading an original or a process of writing an image on a sheet and various image processing. The controller unit 200 performs the receiving of print data input from an external interface (I/F), the delivery of a scanner image, and the storage of image data.

The engine control unit 100 includes an engine central processing unit (CPU) 110, an engine image processing unit 120, the CCD 130, the CIS 140, and the LDs 150.

The engine CPU 110 controls the engine control unit 100 overall. The CCD 130 reads an original put on the contact glass 11 and generates an RGB image. The CIS 140 reads an original conveyed by the ADF 20 and generates an RGB image. Then, the CCD 130 and the CIS 140, which are a reader, read each original once. If provided with two CCDs 130 and two CISs 140, the image forming apparatus 1 can read both sides of an original at the same time. Each LD 150 irradiates the corresponding photoconductor drum 121 with a laser light modulated on the basis of image data to be printed to form an image.

The engine image processing unit 120 performs various image processing. The engine image processing unit 120 includes a read-image processing unit 111, a writing-image processing unit 112, and a serial-communication control unit 113.

The read-image processing unit 111 controls the reading of an original and generation of an RGB image using the CCD 130 or the CIS 140. Furthermore, on the read RGB image, the read-image processing unit 111 performs modulation transfer function (MTF) correction, smoothing filter correction, generation of a CMYK image from the RGB image, generation of a monoK image from the RGB image, color correction, image processing, and encoding (compression).

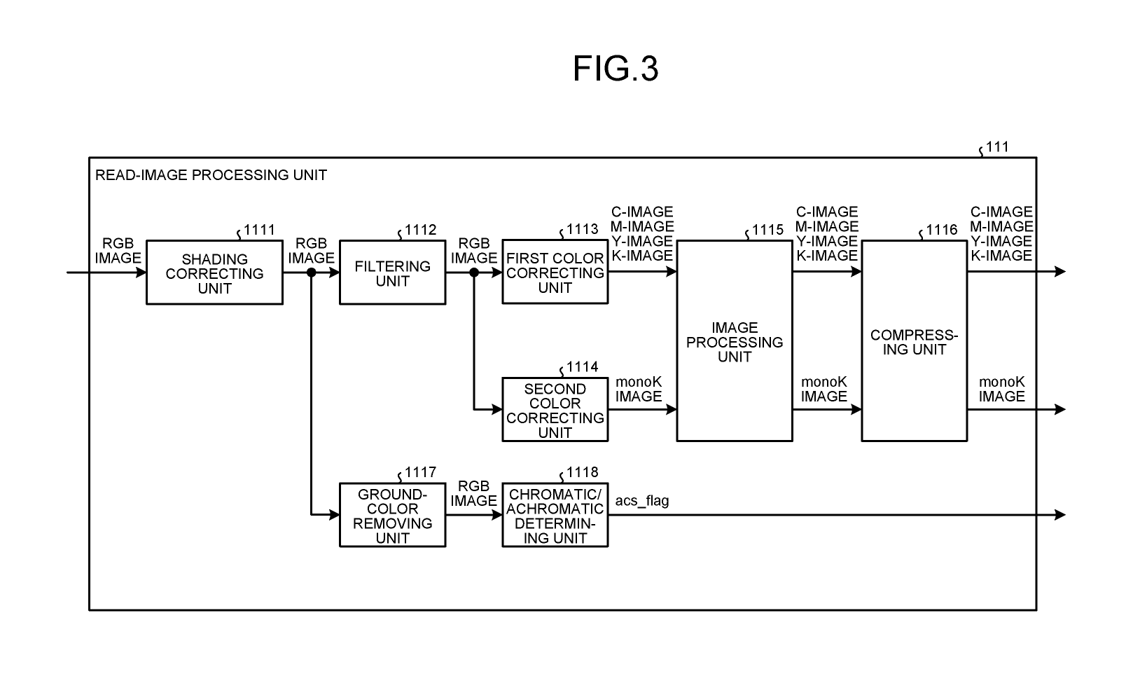

FIG. 3 is a functional block diagram showing an example of a functional configuration of the read-image processing unit 111 according to the first embodiment. The read-image processing unit 111 includes a shading correcting unit 1111, a filtering unit 1112, a first color correcting unit 1113, a second color correcting unit 1114, an image processing unit 1115, a compressing unit 1116, a ground-color removing unit 1117, and a chromatic/achromatic determining unit 1118.

The shading correcting unit 1111 corrects density unevenness of an RGB image. Then, the shading correcting unit 1111 outputs the corrected RGB image to the filtering unit 1112 and the ground-color removing unit 1117.

The filtering unit 1112 improves the image quality of an RGB image by performing a smoothing or edge enhancement process on the RGB image. Then, the filtering unit 1112 outputs the RGB image with the improved image quality to the first color correcting unit 1113 and the second color correcting unit 1114.

The first color correcting unit 1113, which is a first color corrector, generates a CMYK image for color output from the RGB image with the image quality improved by the filtering unit 1112. That is, the first color correcting unit 1113 generates CMYK image information for color output.

The second color correcting unit 1114, which is a second color corrector, generates a monoK image for monochrome output from the RGB image with the image quality improved by the filtering unit 1112. That is, the second color correcting unit 1114 generates monoK image information for monochrome output. Incidentally, the second color correcting unit 1114 generates the monoK image for monochrome output regardless of determination by the chromatic/achromatic determining unit 1118. Therefore, the second color correcting unit 1114 starts the generation of the monoK image before the chromatic/achromatic determining unit 1118 determines whether the read original is color or monochrome. Accordingly, when the chromatic/achromatic determining unit 1118 has determined that the original is monochrome, the image processing apparatus 10 can immediately output the monoK image.

The image processing unit 1115 performs the changing of the resolution to a designated value, the scaling such as enlargement or reduction, the adjustment of an image position, etc. The compressing unit 1116 compresses an image generated by the image processing unit 1115. The compressing unit 1116 compresses the image in a fixed-length format or a JPEG format. The compressing unit 1116 compresses the image, thereby reducing the load on the subsequent serial-communication control unit 113.

The ground-color removing unit 1117 detects a ground color level of an RGB image output from the shading correcting unit 1111. Then, the ground-color removing unit 1117 removes the detected ground color level from each of R, G, and B plates. Consequently, the ground-color removing unit 1117 prevents the subsequent chromatic/achromatic determining unit 1118 from making erroneous detection.

The chromatic/achromatic determining unit 1118 determines whether an original read by the CCD 130 or the CIS 140 is color or monochrome. Specifically, the chromatic/achromatic determining unit 1118 performs the CMYKRGB-hue-segmentation-based color determination on an RGB image with the ground color removed. That is, the chromatic/achromatic determining unit 1118 determines which of cyan (C), magenta (M), yellow (Y), black (K), red (R), green (G), and blue (B) colors each pixel of the RGB image falls into. Then, the chromatic/achromatic determining unit 1118 determines whether it is a color original or a monochrome original by the number of pixels in a specified area that have been determined to be a chromatic pixel.

At this time, the chromatic/achromatic determining unit 1118 performs a process of determining whether a prescribed number of chromatic pixels are included in the specified area on the RGB image of one page. When having determined that a prescribed number of chromatic pixels or more are included in a partial area of the original, the chromatic/achromatic determining unit 1118 determines that it is a color original. On the other hand, when having determined in the determining process performed on the RGB image of one page that the original is not a color original, the chromatic/achromatic determining unit 1118 determines that it is a monochrome original. That is, when having completed the determining process performed on the RGB image of one page, the chromatic/achromatic determining unit 1118 can determine that it is a monochrome original.

Then, the chromatic/achromatic determining unit 1118 outputs an acs_flag, which is a result of the determination, to the controller unit 200. Here, when the original is chromatic, the chromatic/achromatic determining unit 1118 outputs a High-level acs_flag to the controller unit 200. On the other hand, when the original is achromatic, the chromatic/achromatic determining unit 1118 outputs a Low-level acs_flag to the controller unit 200.

In this way, an RGB image that the CCD 130 or the CIS 140 has read from an original is output to the first color correcting unit 1113, the second color correcting unit 1114, and the chromatic/achromatic determining unit 1118. Then, the first color correcting unit 1113 outputs a generated CMYK image to the controller unit 200 through the image processing unit 1115 and the compressing unit 1116. The second color correcting unit 1114 outputs a generated monoK image to the controller unit 200 through the image processing unit 1115 and the compressing unit 1116. The chromatic/achromatic determining unit 1118 outputs an acs_flag, which is a result of determination, to the controller unit 200.

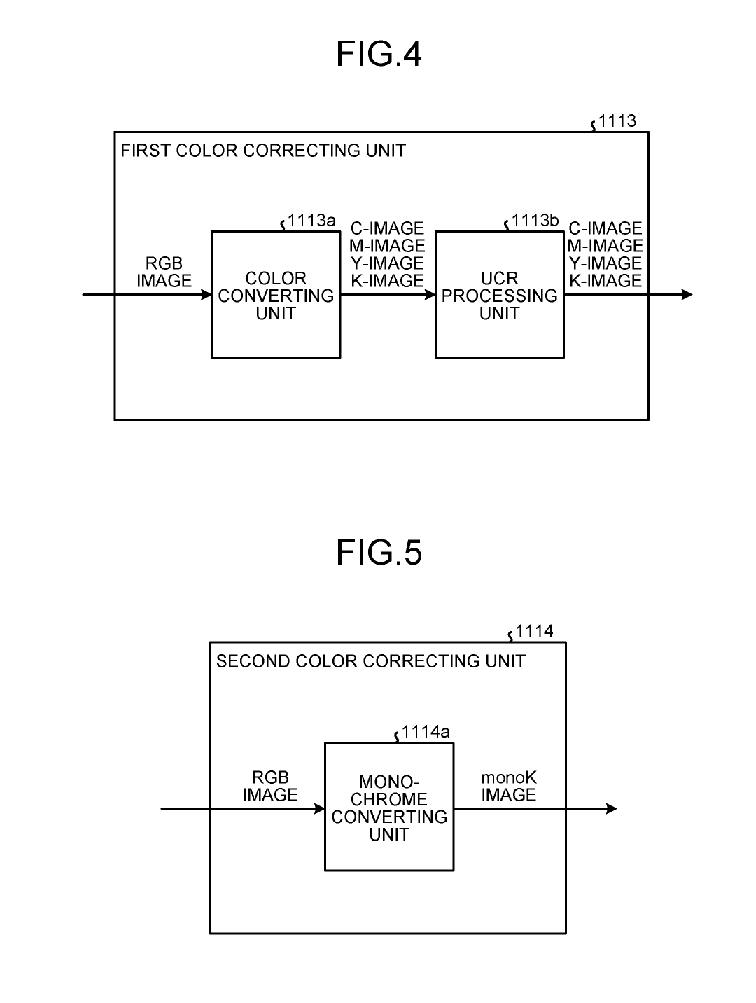

Subsequently, a functional configuration of the first color correcting unit 1113 is explained. FIG. 4 is a functional block diagram showing an example of the functional configuration of the first color correcting unit 1113 according to the first embodiment.

The first color correcting unit 1113 includes a color converting unit 1113a and a under color removal (UCR) processing unit 1113b. The color converting unit 1113a generates four pieces of C, M, Y, and K-image information by 12-hue segmentation linear masking product-sum operation. Specifically, the color converting unit 1113a generates a signal using the following Equation (1).

$$sum\_x = coef\_r \_x [ hue ] * r + coef\_g \_x [ hue ] * g + coef\_b \_x [ hue ] * b + const\_x \qquad ( 1 )$$

Variables in Equation (1) are as follows.

x: C, M, Y, K

hue: 0 to 11 hue information

coef_r_x, coef_g_x, coef_b_x: Correction coefficient of each hue

const_x: Fixed adjustment value

The UCR processing unit 1113b performs under color removal. Even when equal amounts of C, M, and Y toners are superimposed and printed, the color of the superimposed toners does not become achromatic color (gray or black color). Therefore, the UCR processing unit 1113b uses C, M, Y, and K toners and adds a specific amount of K toner, and then removes the C, M, and Y toners. Accordingly, the UCR processing unit 1113b improves the achromatic color reproducibility and reduces the amounts of C, M, and Y toners.

Subsequently, a functional configuration of the second color correcting unit 1114 is explained. FIG. 5 is a functional block diagram showing an example of the functional configuration of the second color correcting unit 1114 according to the first embodiment. The second color correcting unit 1114 includes a monochrome converting unit 1114a. The monochrome converting unit 1114a generates a monoK image by converting an RGB image into a luminance signal Y by 12-hue segmentation linear masking product-sum operation in the same way as the first color correcting unit 1113. Equation (2) is known as a general equation for conversion from RGB to luminance signal.

Y=0.299*R+0.587*G+0.114*B (2)

In the conversion to a monoK image, the monochrome converting unit 1114a adjusts the correction coefficients according to engine characteristics. Specifically, the monochrome converting unit 1114a adjusts the correction coefficients using the following Equation (3), and generates a monoK image.

$$monoK = coef\_r \_monok [ hue ] * r + coef\_g \_monok [ hue ] * g + coef\_b \_monok [ hue ] * b + const\_monok \qquad ( 3 )$$

Variables in Equation (3) are as follows.

hue: 0 to 11 hue information

coef_r_monok, coef_g_monok, coef_b_monok: Correction coefficient of each hue

const_monok: Fixed adjustment value

To return to FIG. 2, the writing-image processing unit 112 outputs image information, which has been output from the controller unit 200, to the LDs 150 at timings depending on the image formations by the image forming stations 12, i.e., the interval between the photoconductor drums 121. The writing-image processing unit 112 performs the decoding (decompression) of a CMYK image, the gradation processing of normal color image data, the resolution conversion and scaling of a stamp image or a ground tint image, a process of shifting pieces of C, M, Y, and K-image information, and a process of synthesizing the pieces of image information. Then, the writing-image processing unit 112, which is an output unit, causes the LDs 150 to form a CMYK image generated by the first color correcting unit 1113 or a monoK image generated by the second color correcting unit 1114 and print out the formed image on a sheet on the basis of a result of determination by the chromatic/achromatic determining unit 1118.

The serial-communication control unit 113 connects the engine control unit 100 to the controller unit 200. The serial-communication control unit 113 is, for example, a high-speed serial I/F such as a Peripheral Component Interconnect (PCI)-Express I/F. The serial-communication control unit 113 transmits a total of five plates of image information: four plates of image information of C, M, Y, and K images and one plate of image information of a monoK image.

The controller unit 200 performs the receiving of print data from an external I/F, the delivery of a scanner image, and the storage of image data. The controller unit 200 includes a controller image processing unit 210, a controller CPU 230, a controller memory 240, an external-I/F control unit 250, and a hard disk drive (HDD) 260.

The controller CPU 230 performs the control of the controller unit 200, the translation of print data, the drawing of a print image, the drawing of a stamp image, the drawing of a ground tint image, a process of compressing an image to Joint Photographic Experts Group (JPEG) data, and a process of decompressing the JPEG data to the image. Furthermore, the controller CPU 230 stores an input CMYK image and an input monoK image in the controller memory 240. Then, when an acs_flag has been input from the chromatic/achromatic determining unit 1118, the controller CPU 230 outputs the CMYK image for color or the monoK image for monochrome to the engine control unit 100 according to the acs_flag.

The controller memory 240 temporarily stores therein various programs, and stores therein various data in a rewritable manner. Furthermore, the controller memory 240 is a work memory used for the temporary storage of received print data, a print image, a stamp image, a ground tint image, a normal color image, a read image, etc. Moreover, the controller memory 240 temporarily stores therein a CMYK image for color output and a monoK image for monochrome output which have been output from the engine control unit 100.

The external-I/F control unit 250 controls the connection to an external communication device via a network. Specifically, the external-I/F control unit 250 controls the transfer of an image to the outside and the input of print data from the outside.

The HDD 260 stores therein various programs and images. The controller image processing unit 210 performs various image processing. The controller image processing unit 210 includes an input controller 212, an output controller 213, a controller internal-bus control unit 214, a serial-communication control unit 215, a rotator 216, an editor 217, a compressor 218, a decompressor 219, and an HDD controller 220.

The input controller 212 receives the input of a CMYK image and a monoK image from the engine control unit 100. The output controller 213 outputs the CMYK image or the monoK image to the engine control unit 100. The controller internal-bus control unit 214 performs the bus switching and bus arbitration between functional blocks. The serial-communication control unit 215 connects the controller unit 200 to the engine control unit 100. The serial-communication control unit 215 is, for example, a high-speed serial I/F such as a PCI-Express I/F. The rotator 216 and the editor 217 perform image processing of a print image or a read image. The compressor 218 performs data compression when the print image or the read image is stored. The decompressor 219 decompresses the stored compressed data to the original image data. The HDD controller 220 controls the writing of data to the HDD 260 and the readout of data from the HDD 260.

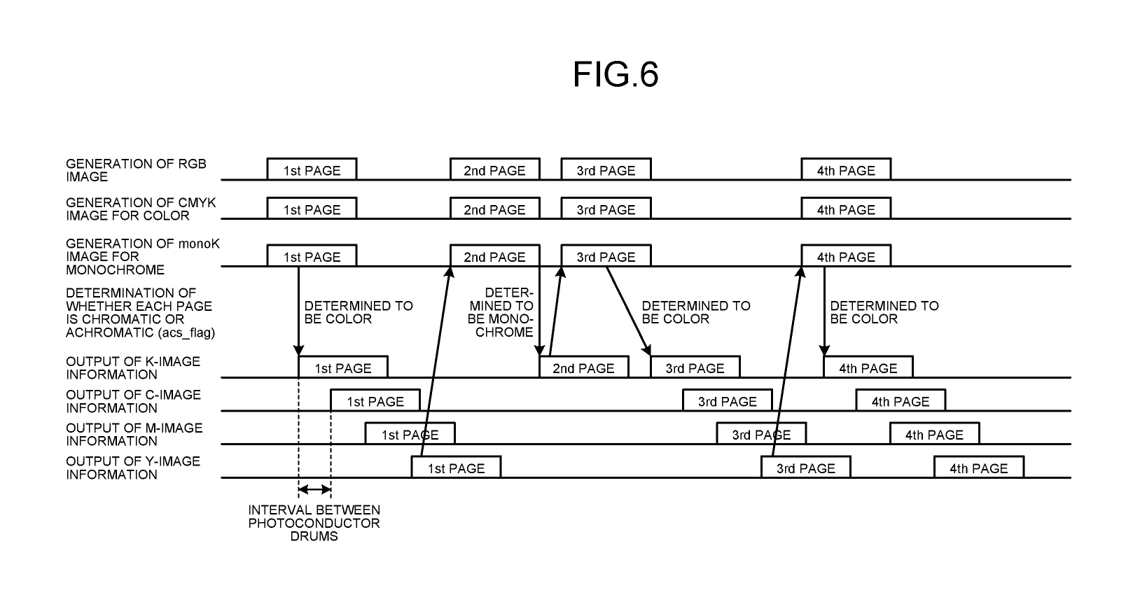

Subsequently, a copy operation of the engine control unit 100 and the controller unit 200 of the image forming apparatus 1 according to the first embodiment is explained with a timing chart. FIG. 6 is the timing chart of the copy operation according to the first embodiment. Incidentally, FIG. 6 shows the illustration of a major copy operation pertaining to the image forming apparatus 1. Furthermore, the timing chart shown in FIG. 6 indicates that the first, third, and fourth pages are color originals and the second page is a monochrome original.

First, the first page which is a color original is explained.

The CIS 140 reads an original conveyed by the ADF 20 and generates an RGB image. The first color correcting unit 1113 generates a CMYK image for color output from the RGB image input through the shading correcting unit 1111 and the filtering unit 1112. Then, the controller CPU 230 stores the generated CMYK image for color output in the controller memory 240.

The second color correcting unit 1114 generates a monoK image for monochrome output from the RGB image input through the shading correcting unit 1111 and the filtering unit 1112. At this time, the second color correcting unit 1114 starts the generation of the monoK image regardless of a result of determination by the chromatic/achromatic determining unit 1118. Then, the controller CPU 230 stores the generated monoK image for monochrome output in the controller memory 240.

The chromatic/achromatic determining unit 1118 determines whether the original is color or monochrome on the basis of the RGB image input through the shading correcting unit 1111 and the ground-color removing unit 1117. Since the first page is a color original, the chromatic/achromatic determining unit 1118 outputs a High-level acs_flag to the controller unit 200.

When the original has been determined to be a color original, the controller CPU 230 sequentially outputs the CMYK image stored in the controller memory 240 to the writing-image processing unit 112. First, the controller CPU 230 outputs the K-image to the writing-image processing unit 112. Then, the controller CPU 230 outputs the C-image to the writing-image processing unit 112. Then, the controller CPU 230 outputs the M-image to the writing-image processing unit 112. And then, the controller CPU 230 outputs the Y-image to the writing-image processing unit 112.

The writing-image processing unit 112 outputs four pieces of K, C, M, and Y-image information to the LDs 150 at timings depending on the image formations by the image forming stations 12, respectively. That is, the intervals of transfer of the four pieces of image information of the same page depend on the interval between the photoconductor drums 121. Accordingly, the photoconductor drums 121 can transfer color image information onto the intermediate transfer belt 13 without misregistration.

Then, when the writing-image processing unit 112 has started outputting last-color image information to the LD 150, the CIS 140 starts reading the next original. Consequently, the engine CPU 110 prevents the information stored in the controller memory 240 from being overwritten. Incidentally, if the controller memory 240 has a capacity to store CMYK and monoK images of the next original, the engine CPU 110 can start the reading of the next original without waiting for the output of the last-color image information.

Next, the second page which is a monochrome original is explained.

Just like a color original, the first color correcting unit 1113 outputs a CMYK image for color output to the controller unit 200. Then, the controller CPU 230 stores the CMYK image for color output in the controller memory 240.

Furthermore, the engine control unit 100 outputs a monoK image for monochrome output to the controller unit 200. Then, the controller CPU 230 stores the monoK image for monochrome output in the controller memory 240.

Then, the chromatic/achromatic determining unit 1118 determines whether the original is color or monochrome. In this case, the second page is a monochrome original. Therefore, after reading the original, the chromatic/achromatic determining unit 1118 outputs a Low-level acs_flag to the controller unit 200. That is, after reading the original, the controller CPU 230 outputs a K-image to the writing-image processing unit 112.

At this time, since the K-image is last-color image information, the CIS 140 starts reading the next original.

The third and fourth-page originals are color originals. The image forming apparatus 1 performs the same process as the first page.

As described above, according to the image processing apparatus 10 in the first embodiment, the read-image processing unit 111 outputs an RGB image of an original read by the CCD 130 or the CIS 140 to the first color correcting unit 1113, the second color correcting unit 1114, and the chromatic/achromatic determining unit 1118. The first color correcting unit 1113 generates a CMYK image for color output from the RGB image. Then, the CMYK image is output to the controller unit 200. The second color correcting unit 1114 generates a monoK image for monochrome output from the RGB image. Then, the monoK image is output to the controller unit 200. The chromatic/achromatic determining unit 1118 determines whether the original is monochrome or color from the RGB image. Then, a result of the determination is output to the controller unit 200. The controller CPU 230 outputs the CMYK image or the monoK image to the engine control unit 100 on the basis of the result of the determination. The engine control unit 100 prints out image information output through the LDs 150.

Furthermore, regardless of whether an original is color or monochrome, the image forming apparatus 1 creates both a CMYK image for color output and a monoK image for monochrome output in one read operation. Therefore, when the original has been determined to be color by a result of determination, the image forming apparatus 1 prints the CMYK image; on the other hand, even when the original has been determined to be monochrome, the image forming apparatus 1 can immediately print the monoK image. Moreover, the number of times of reading of an original is just once, so there is no pixel position shift, and therefore, the image forming apparatus 1 can prevent image degradation.

Furthermore, in a conventional way to output a monochrome image, the controller CPU 230 would create a monoK image for monochrome output anew from a CMYK image for color output on the controller memory 240. Therefore, in the conventional way, load is applied to the controller CPU 230, and there is required a time to convert from the CMYK image to the monoK image, thereby the original reading interval is extended, resulting in a decrease in the productivity. However, the image processing apparatus 10 according to the first embodiment can perform the output of an image just by selecting an area of a monoK image as a process performed by the controller unit 200; therefore, it is possible to reduce the CPU load.

### Second Embodiment

Subsequently, a second embodiment is explained. Differences from the first embodiment are mainly explained below. A component having the same function as in the first embodiment is assigned the same name and reference numeral as in the first embodiment, and description of the component is omitted.

In the image forming apparatus 1 according to the first embodiment, the read-image processing unit 111 generates both a CMYK image for color and a monoK image for monochrome regardless of whether an original is color or monochrome. Furthermore, the read-image processing unit 111 generates an acs_flag which indicates whether the original is color or monochrome. Then, the controller CPU 230 outputs either the CMYK image for color or the monoK image for monochrome according to the acs_flag. Consequently, even when using an ACS function, the image forming apparatus 1 according to the first embodiment can make the reading of an original just once.

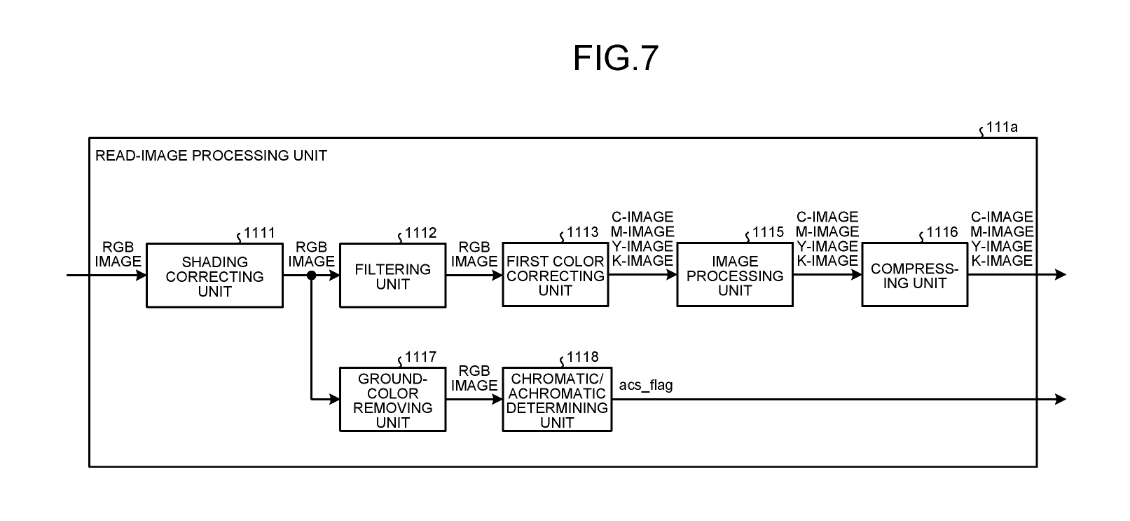

On the other hand, the first color correcting unit 1113 of a read-image processing unit 111a according to the second embodiment generates a CMYK image for color. And, the chromatic/achromatic determining unit 1118 of the read-image processing unit 111a generates an acs_flag which indicates whether an original is color or monochrome. Then, if the acs_flag indicates monochrome, an output controller 213a (see FIG. 7) generates a monoK image for monochrome from the input CMYK image for color. Then, the output controller 213a outputs the monoK image for monochrome. On the other hand, if the acs_flag indicates color, the output controller 213a outputs the CMYK image for color. Consequently, even when using the ACS function, an image forming apparatus 1a according to the second embodiment can make the reading of an original just once.

Subsequently, the read-image processing unit 111a according to the second embodiment is explained. FIG. 7 is a functional block diagram showing a functional configuration of the read-image processing unit 111a according to the second embodiment.

The read-image processing unit 111a according to the second embodiment includes the shading correcting unit 1111, the filtering unit 1112, the first color correcting unit 1113, the image processing unit 1115, the compressing unit 1116, the ground-color removing unit 1117, and the chromatic/achromatic determining unit 1118. That is, the read-image processing unit 111a according to the second embodiment differs from the read-image processing unit 111 according to the first embodiment in that the second color correcting unit 1114 is not included in the read-image processing unit 111a.

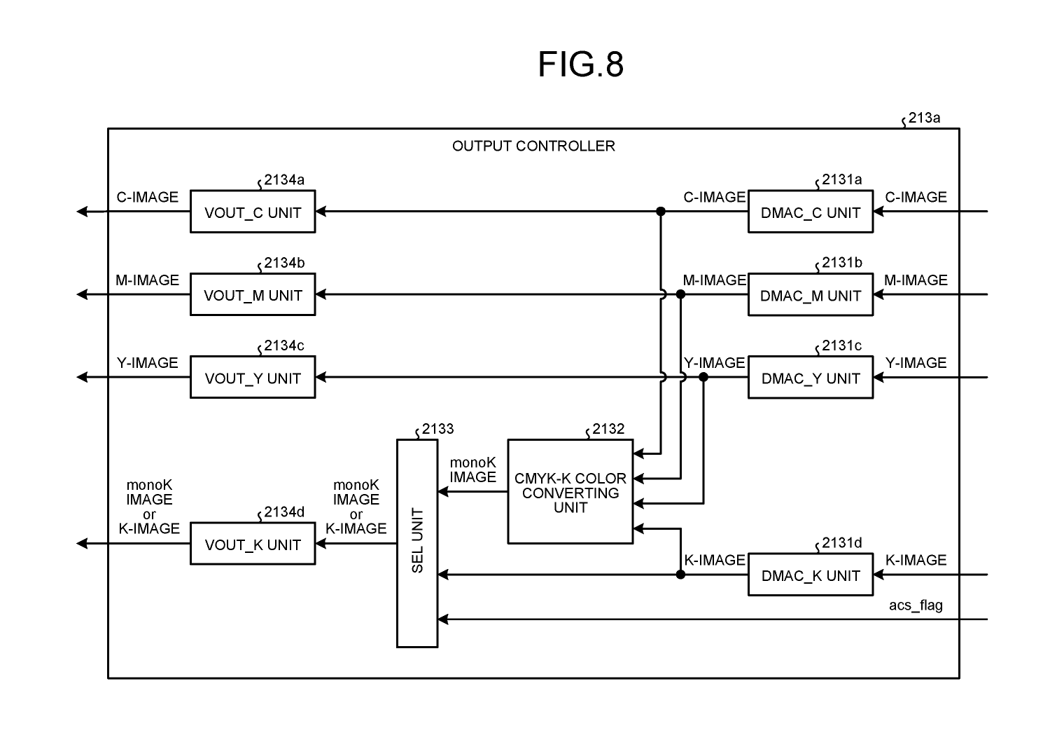

Subsequently, the output controller 213a according to the second embodiment is explained. FIG. 8 is a functional block diagram showing a functional configuration of the output controller 213a according to the second embodiment.

The output controller 213a includes a DMAC_C unit 2131a, a DMAC_M unit 2131b, a DMAC_Y unit 2131c, a DMAC_K unit 2131d, a CMYK-K color converting unit 2132, a SEL unit 2133, a VOUT_C unit 2134a, a VOUT_M unit 2134b, a VOUT_Y unit 2134c, and a VOUT_K unit 2134d.

The DMAC_C unit 2131a, the DMAC_M unit 2131b, the DMAC_Y unit 2131c, and the DMAC_K unit 2131d are a direct memory access controller (DMAC). The DMAC_C unit 2131a, the DMAC_M unit 2131b, the DMAC_Y unit 2131c, and the DMAC_K unit 2131d output a CMYK image stored in the controller memory 240 on the basis of a result of determination by the chromatic/achromatic determining unit 1118.

The DMAC_C unit 2131a outputs a C-image stored in the controller memory 240 to the VOUT_C unit 2134a when the chromatic/achromatic determining unit 1118 has determined that an original is color. On the other hand, when the chromatic/achromatic determining unit 1118 has determined that the original is monochrome, the DMAC_C unit 2131a outputs the C-image stored in the controller memory 240 to the CMYK-K color converting unit 2132.

The DMAC_M unit 2131b outputs an M-image stored in the controller memory 240 to the VOUT_M unit 2134b when the chromatic/achromatic determining unit 1118 has determined that the original is color. On the other hand, when the chromatic/achromatic determining unit 1118 has determined that the original is monochrome, the DMAC_M unit 2131b outputs the M-image stored in the controller memory 240 to the CMYK-K color converting unit 2132.

The DMAC_Y unit 2131c outputs a Y-image stored in the controller memory 240 to the VOUT_Y unit 2134c when the chromatic/achromatic determining unit 1118 has determined that the original is color. On the other hand, when the chromatic/achromatic determining unit 1118 has determined that the original is monochrome, the DMAC_Y unit 2131c outputs the Y-image stored in the controller memory 240 to the CMYK-K color converting unit 2132.

The DMAC_K unit 2131d outputs a K-image stored in the controller memory 240 to the SEL unit 2133 when the chromatic/achromatic determining unit 1118 has determined that the original is color. On the other hand, when the chromatic/achromatic determining unit 1118 has determined that the original is monochrome, the DMAC_K unit 2131d outputs the K-image stored in the controller memory 240 to the CMYK-K color converting unit 2132.

The CMYK-K color converting unit 2132 generates a monoK image from the C, M, Y, and K-images output from the DMAC_C unit 2131a, the DMAC_M unit 2131b, the DMAC_Y unit 2131c, and the DMAC_K unit 2131d. That is, when the chromatic/achromatic determining unit 1118 has determined that the original is monochrome, the CMYK-K color converting unit 2132, which is a color converter, generates a monoK image from the CMYK image. The CMYK-K color converting unit 2132 generates the monoK image by 12-hue segmentation linear masking product-sum operation. Specifically, the CMYK-K color converting unit 2132 generates the monoK image using the following Equation (4).

$$monoK = coef\_c \_monok [ hue ] * c + coef\_m \_monok [ hue ] * m + coef\_y \_monok [ hue ] * y + coef\_k \_monok [ hue ] * k + const\_monok \qquad ( 4 )$$

Variables in Equation (4) are as follows.

hue: 0 to 11 hue information

coef_c_monok, coef_m_monok, coef_y_monok, coef_k_monok: Correction coefficient of each hue

const_monok: Fixed adjustment value

The DMAC_C unit 2131a, the DMAC_M unit 2131b, the DMAC_Y unit 2131c, and the DMAC_K unit 2131d output C, M, Y, and K-images on the basis of a result of determination by the chromatic/achromatic determining unit 1118, respectively. The CMYK-K color converting unit 2132 generates a monoK image using Equation (4). That is, the CMYK-K color converting unit 2132 generates the monoK image from four pieces of C, M, Y, and K-image information. Accordingly, the CMYK-K color converting unit 2132 needs the C, M, Y, and K-image information to generate the monoK image; therefore, the C, M, Y, and K-image information need to be input at about the same timing. Incidentally, the timing to input the C, M, Y, and K-image information varies according to the amount of a buffer included in the CMYK-K color converting unit 2132.

The SEL unit 2133 outputs a K-image for color or a monoK image for monochrome according to an acs_flag. Specifically, if the acs_flag is High level, the SEL unit 2133 outputs a K-image for color to the VOUT_K unit 2134d. On the other hand, if the acs_flag is Low level, the SEL unit 2133 outputs a monoK image for monochrome to the VOUT_K unit 2134d.

The VOUT_C unit 2134a, the VOUT_M unit 2134b, the VOUT_Y unit 2134c, and the VOUT_K unit 2134d are each equipped with one or more FIFOs (First In, First Out). Accordingly, the VOUT_C unit 2134a, the VOUT_M unit 2134b, the VOUT_Y unit 2134c, and the VOUT_K unit 2134d have a buffering function.

The VOUT_C unit 2134a, the VOUT_M unit 2134b, the VOUT_Y unit 2134c, and the VOUT_K unit 2134d output image information to the writing-image processing unit 112 through the serial-communication control units 211 and 113 at the timing depending on the interval between the photoconductor drums 121.

The VOUT_C unit 2134a buffers a C-image output from the DMAC_C unit 2131a and outputs the C-image to the writing-image processing unit 112 through the serial-communication control units 211 and 113. The VOUT_M unit 2134b buffers an M-image output from the DMAC_M unit 2131b and outputs the M-image to the writing-image processing unit 112 through the serial-communication control units 211 and 113. The VOUT_Y unit 2134c buffers a Y-image output from the DMAC_Y unit 2131c and outputs the Y-image to the writing-image processing unit 112 through the serial-communication control units 211 and 113. The VOUT_K unit 2134d buffers a K-image output from the SEL unit 2133 and outputs the K-image or a monoK image to the writing-image processing unit 112 through the serial-communication control units 211 and 113.

Then, the writing-image processing unit 112 outputs four pieces of C, M, Y, and K-image information to the LDs 150 at timings depending on the image formations by the image forming stations 12.

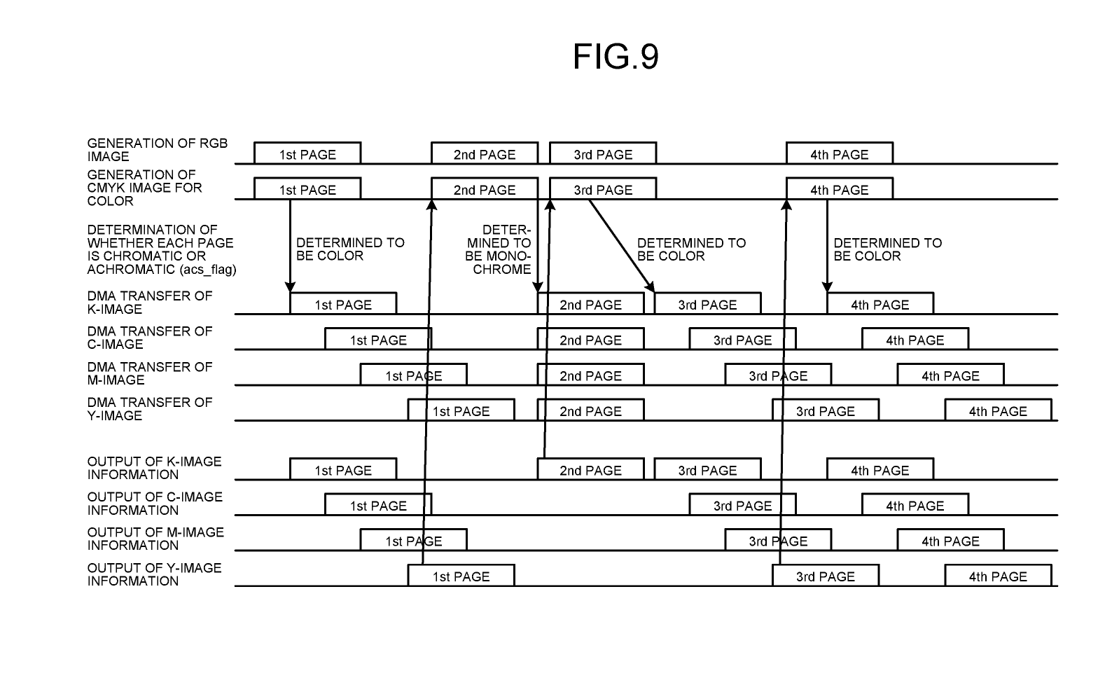

Subsequently, a copy operation of the image forming apparatus 1a according to the second embodiment when using the ACS function is explained with a timing chart. FIG. 9 is the timing chart of the copy operation according to the second embodiment. Incidentally, FIG. 9 shows the illustration of a major copy operation of the image forming apparatus 1a according to the second embodiment. Furthermore, the timing chart shown in FIG. 9 indicates that the first, third, and fourth pages are color originals and the second page is a monochrome original.

First, the first page which is a color original is explained.

The CIS 140 reads an original conveyed by the ADF 20 and generates an RGB image. The read-image processing unit 111a generates a CMYK image for color output from the RGB image. Furthermore, the chromatic/achromatic determining unit 1118 of the read-image processing unit 111a determines whether the original is color or monochrome. Since the first page is a color original, the chromatic/achromatic determining unit 1118 outputs a High-level acs_flag to the controller unit 200.

When the chromatic/achromatic determining unit 1118 has performed the chromatic/achromatic determination, the DMAC_K unit 2131d outputs a K-image stored in the controller memory 240 to the SEL unit 2133.

Since the first page is a color original, the SEL unit 2133 outputs the K-image for color to the VOUT_K unit 2134d. Then, the VOUT_K unit 2134d outputs the K-image to the writing-image processing unit 112.

Then, the DMAC_C unit 2131a outputs a C-image for color to the VOUT_C unit 2134a. Then, the VOUT_C unit 2134a outputs the C-image to the writing-image processing unit 112. Then, the DMAC_M unit 2131b outputs an M-image for color to the VOUT_M unit 2134b. Then, the VOUT_M unit 2134b outputs the M-image to the writing-image processing unit 112. Then, the DMAC_Y unit 2131c outputs a Y-image for color to the VOUT_Y unit 2134c. Then, the VOUT_Y unit 2134c outputs the Y-image to the writing-image processing unit 112.

The writing-image processing unit 112 outputs four pieces of C, M, Y, and K-image information to the LDs 150 at timings depending on the image formations by the image forming stations 12, respectively. That is, the intervals of transfer of the pieces of C, M, Y, and K-image information of the same page depend on the interval between the photoconductor drums 121. Accordingly, the photoconductor drums 121 can transfer the pieces of C, M, Y, and K-image information onto the intermediate transfer belt 13 without misregistration.

Then, when the writing-image processing unit 112 has started outputting last-color image information to the LD 150, the engine CPU 110 causes the CCD 130 or the CIS 140 to start reading the next original.

Next, the second page which is a monochrome original is explained.

Just like a color original, the read-image processing unit 111 outputs a CMYK image for color output to the controller unit 200. Then, the controller CPU 230 stores the CMYK image for color output in the controller memory 240. Since the second page is a monochrome original, the chromatic/achromatic determining unit 1118 outputs a Low-level acs_flag to the controller unit 200.

In the case of a monochrome original, the CMYK-K color converting unit 2132 generates a monoK image for monochrome. Therefore, the DMAC_K unit 2131d, the DMAC_C unit 2131a, the DMAC_M unit 2131b, and the DMAC_Y unit 2131c output K, C, M, and Y-image information stored in the controller memory 240 at about the same timing.

That is, the DMAC_K unit 2131d outputs a K-image to the CMYK-K color converting unit 2132. The DMAC_C unit 2131a outputs a C-image to the CMYK-K color converting unit 2132. The DMAC_M unit 2131b outputs an M-image to the CMYK-K color converting unit 2132. The DMAC_Y unit 2131c outputs a Y-image to the CMYK-K color converting unit 2132.

The CMYK-K color converting unit 2132 generates a monoK image from the K, C, M, and Y-image information. Then, since the second page is a monochrome original, the SEL unit 2133 outputs the monoK image to the VOUT_K unit 2134d.

The VOUT_K unit 2134d outputs the monoK image to the writing-image processing unit 112. The writing-image processing unit 112 outputs the monoK image to the LD 150.

At this time, since the monoK image is last-color image information, the engine CPU 110 starts the reading of the next original.

The third and fourth-page originals are color originals. The image forming apparatus 1a performs the same process as the first page.

As described above, according to the image processing apparatus 10 in the second embodiment, the read-image processing unit 111a outputs an RGB image of an original read by the CCD 130 or the CIS 140 to the first color correcting unit 1113 and the chromatic/achromatic determining unit 1118. The first color correcting unit 1113 generates a CMYK image for color output from the RGB image. Then, the CMYK image is output to the controller unit 200. The chromatic/achromatic determining unit 1118 determines whether the original is monochrome or color from the RGB image. Then, a result of the determination is output to the output controller 213a. The SEL unit 2133 of the output controller 213a outputs the CMYK image or a monoK image to the engine control unit 100 on the basis of the result of the determination. The engine control unit 100 prints out the image output through the LDs 150. Therefore, it is possible to increase the productivity while preventing image degradation.

Furthermore, according to the image processing apparatus 10 in the second embodiment, hardware (the CMYK-K color converting unit 2132) performs the creation of a monoK image for monochrome output. Therefore, the image processing apparatus 10 according to the second embodiment can reduce the CPU load because the controller CPU 230 does not have to create a monoK image on the controller memory 240.

According to an embodiment, it is possible to increase the productivity while preventing image degradation.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
a reader configured to read an original to generate original image data;
a first color corrector configured to generate CMYK-image information for outputting the original in color from the original image data;
a second color corrector configured to generate K-image information for outputting the original in monochrome from the original image data;
a determiner configured to determine whether the original is color or monochrome, using the original image data; and
an output unit configured to output the CMYK-image information or the K-image information based on a result of determination by the determiner.

2. The image processing apparatus according to claim 1, wherein
the second color corrector starts generation of the K-image information regardless of the result of the determination by the determiner, and
the output unit outputs the CMYK-image information or the K-image information based on the result of the determination by the determiner.

3. The image processing apparatus according to claim 1, wherein
the reader starts reading a next original when the output unit has output last-color image information of the original.

4. The image processing apparatus according to claim 2, wherein
the reader starts reading a next original when the output unit has output last-color image information of the original.

5. An image forming apparatus comprising:
the image processing apparatus according to claim 1; and
an image forming unit configured to perform image formation based on the CMYK-image information or K-image information output from the image processing apparatus.

6. An image processing apparatus comprising:
a reader configured to read an original to generate original image data;
a first color corrector configured to generate CMYK-image information for outputting the original in color from the original image data;
a determiner configured to determine whether the original is color or monochrome, using the original image data;
a color converter configured to start generation of the K-image information from the CMYK-image information when the determiner determines that the original is monochrome; and
an output unit configured to output the CMYK-image information or the K-image information generated by the color converter based on a result of determination by the determiner.

7. An image forming apparatus comprising:
the image processing apparatus according to claim 6; and
an image forming unit configured to perform image formation based on the CMYK-image information or K-image information output from the image processing apparatus.

8. An image processing method comprising:
reading an original to generate original image data;
generating CMYK-image information for outputting the original in color from the original image data;
generating K-image information for outputting the original in monochrome from the original image data;
determining whether the original is color or monochrome, using the original image data; and
outputting the CMYK-image information or the K-image information based on a result of determination at the determining.
